(19) United States
(12) Patent Application Publication
(10) Pub. No.: US 2006/0069759 A1
(43) Pub. Date: Mar. 30, 2006

(54) Programmatic server page re-tooling

(75) Inventor: Scott H. Snyder, Chapel Hill, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Busines Machines Corporation, Armonk, NY (US)

(21) Appl. No.: 10/878,937

(22) Filed: Jun. 28, 2004

(51) Int. Cl. G06F 15/177

(52) U.S. Cl. 709/221

(57) ABSTRACT

A method, system and apparatus for programmatic server page re-tooling. A server page re-tooling method can include the steps of detecting a condition related to a compiled form of server page code; mapping the detected condition to aspect code; and, weaving the mapped aspect code with the server page code to produce re-tooled server page code. In a preferred aspect of the invention, the detecting step can include detecting one of an operational and an environmental condition. The method further can include the step of providing the re-tooled server page code to a server page compiler. Finally, the method can include the step of compiling and executing the re-tooled server page code.

### BACKGROUND OF THE INVENTION

1. Statement of the Technical Field

The present invention relates to server side logic processing, and more particularly to the re-tooling of a server page in an application server.

2. Description of the Related Art

Traditional client server application mix presentation and business logic in the client tier while the server tier provides backend data storage and server side business logic. Consequently, client server applications typically cannot scale within the enterprise given the difficulty in maintaining both the client tier and the server tier. Specifically, changes to the presentation layer of an application require the modification of the client side application which can impact the integrity of the business logic within the client tier. Similarly, changes to the business logic of the client can jeopardize the integrity of the presentation code in the client tier. Developing for the client tier also can be problematic where logic developers further develop the presentation layer, or where human factors designers develop for the logic layer of the application in the client tier.

To force a separation of the presentation and logic layers as is preferred among contemporary computer scientists, server page technologies have become the preferred vehicle for multi-tier applications. Server page technologies release the client tier from the responsibility of processing logic for rendering the presentation layer. Moreover, server pages largely separate presentation layer logic from the static elements of the presentation layer so that user interface designers can perform changes to the static elements of the presentation layer without breaching the integrity of the programmatic elements of the presentation layer.

Typical server page technologies permit a mixing of statically defined user interface elements and programmatic scripts in a single document. The programmatic scripts can be processed server-side to produce a translated presentation layer document. The translated presentation layer document can be delivered to the client side where the translated presentation layer document can be rendered to a user interface. Notably, in addition to embedded programmatic scripts, the server page further can include macro references to externally defined programmatic logic. In this way, the complexity of the programmatic logic can be hidden from the view of the user interface designer charged with the development and maintenance of the server page.

The JavaServer Page™ (JSP) and the active server page (ASP) represent two popular server page technologies which have been deployed widely in recent years. JSPs, in particular, are a well-known and accepted method of displaying content in a Web application. JSPs combine the ease of use of a markup language document for the Web developer with power and flexibility of a scripting language for the applications developer. Consequently, at present JSPs are the preferred way to display information produced by the business logic of an application deployed within an application server, such as the WebSphere® application server manufactured by the International Business Machines Corporation of Armonk, N.Y., United States of America.

Notably, the ease of use of the JSP stems from the fact that a JSP typically consists mostly of markup, which can be created and managed by a Web developer using familiar development tools. The power of the JSP, on the other hand, stems from the fact that a JSP can contain arbitrary Java code. Advantageously, the jointly formed document can be compiled and the resulting compilation can be executed by a JSP aware Web application server such as the WebSphere application server, much like an ordinary network distributable application. Yet, as an analog to a network distributable application, the server page also must address the operational challenges of the traditional network distributable application.

One challenge relates to the changing nature of an operating environment which hosts the server page. To account for different environmental conditions, the server page code within an operating application server must be able to respond to changing network and system condition. In this regard, it is not always possible to anticipate all of the variations in a run-time environment that are possible. Even where code in a server-page can account for several different operating conditions, it is neither desirable nor feasible to hard code different code paths within a server page for each different operating condition. In fact, to the extent that the handling of different operating conditions transcends the logic of the underlying server page, it is not desirable even to burden the server page developer with the task of coding for contingencies unrelated to the purpose of the server page.

### SUMMARY OF THE INVENTION

The present invention addresses the deficiencies of the art in respect to server page distribution and operation and provides a novel and non-obvious method, system and apparatus for programmatic server page re-tooling. A server page re-tooling method can include the steps of detecting a condition related to a compiled form of server page code; mapping the detected condition to aspect code; and, weaving the mapped aspect code with the server page code to produce re-tooled server page code. In a preferred aspect of the invention, the detecting step can include detecting one of an operational and an environmental condition. The method further can include the step of providing the re-tooled server page code to a server page compiler. Finally, the method can include the step of compiling and executing the re-tooled server page code.

In accordance with the present invention, the server page re-tooling method of the invention also can include the steps of further detecting a different condition related to a compiled form of the re-tooled server page code; further mapping the further detected condition to other aspect code; discarding re-tooled server page code; and, further weaving the further mapped aspect code with the server page code to product additional re-tooled server page code Moreover, the method can include the step of compiling and executing the re-tooled server page code.

A system for programmatically re-tooling a server page can include a server page compiler; and, a re-tooling process communicatively linked to the server page compiler and programmed to re-tool server page code with aspects selected based upon detected conditions. The system further can include a data store of aspects mapped to detectable conditions, the data store having a communicative coupling to the re-tooling processes. The system yet further can include an application server configured for operation with the server page compiler. Finally, the system can include an aspect pre-compiler configured for use by the re-tooling process to produce server page code able to be compiled by the server page compiler.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and apparatus for re-tooling a server page in accordance with the present invention;

FIG. 2 is a schematic illustration of an application server configured for use with the re-tooling system, method and apparatus of FIG. 1; and,

FIG. 3 is a flow chart illustrating a process for re-tooling a server page in the system of FIG. 2.

### DETAILED DESCRIPTION OF THE PREFERRED EMBODIMENTS

The present invention is a method, system and apparatus for programmatic server page re-tooling. In accordance with the present invention, an operational or environmental condition can be detected in association with the hosting of a server page in an application server. Responsive to the detection of the condition, supplemental code can be selected for incorporation into the server page. The supplemental code specifically can address the detected condition. In this regard, the supplemental code can be aspect oriented code configured for execution at a join point within the server page code. In any event, once selected, the supplemental code can be weaved into the code of the server page. Consequently, the server page code can be recompiled and processed by the application server for rendering.

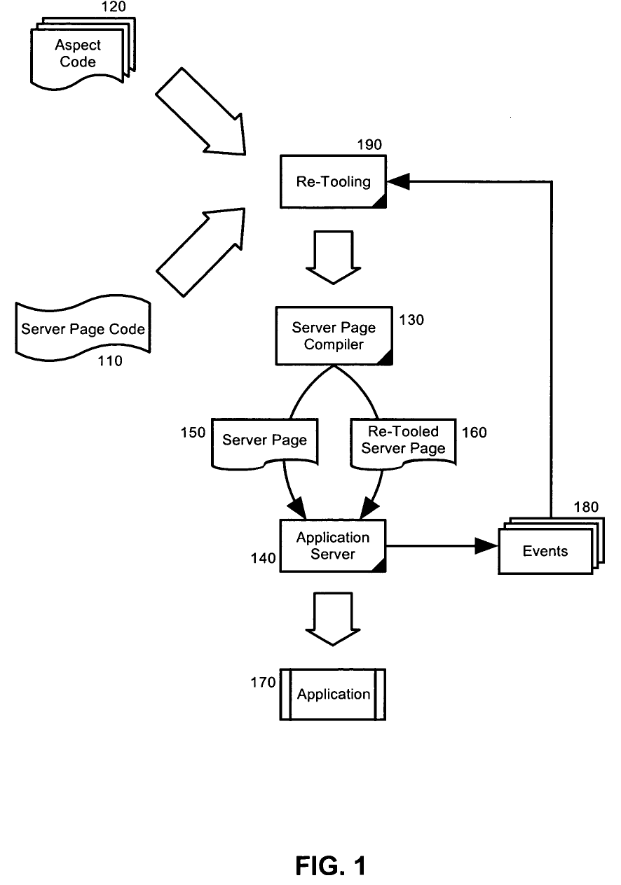

In a particular illustration of a preferred embodiment of the present invention, FIG. 1 is a pictorial illustration of a system, method and apparatus for re-tooling a server page. In accordance with the inventive arrangements, server page code 110 can be compiled by a server page compiler 130 into a server page 150 able to be processed by an application server 140 in an application 170. The application server 140 can monitor and detect either or both of operational and environmental conditions which can be mapped to one or more specified events 180. The operational and environmental conditions can range from server resources to network resources to application performance, to name a few. Moreover, the events 180 can be pre-specified or dynamically defined according to a set of rules.

When one of the specified events 180 can be mapped to a detected condition, a re-tooling process 190 can match the mapped specified events 180 to one or more aspect code snippets 120. The aspect code snippets 120 can include instrumentation for monitoring the performance of the application, as an example and can conform to a known aspect oriented programming mechanism as is well-known in the art. The re-tooling process 190 can direct the weaving of the matched aspect code 120 to specific join points in the server page code 110 so as to produce a re-tooled server page 160 when re-compiled by the server page compiler 130. Notably, in many server page processing systems, a mere change to server page code can result in the automatic recompilation of the server page code. In any case, once recompiled, the re-tooled server page 160 can be distributed and the operation of the server page can be monitored through the application server 140.

It will be recognized by the skilled artisan that by weaving aspect code 120 into the server page code 110, the developer of the server page code 110 can be relieved from concern regarding logic related to the operation and performance of the server page code 110 and not the underlying fuinctionality of the server page code 110. Yet, the logic related to the operation and performance of the server page code 110 need not be included at all times in the server page code 110. Rather, the logic related to the operation and performance of the server page code 110 can be included conditionally responsive only to the occurrence of a specified event. Moreover, the conditional inclusion of the logic related to the operation and performance of the server page code 110 can be processed outside of the operation of the server page code 110.

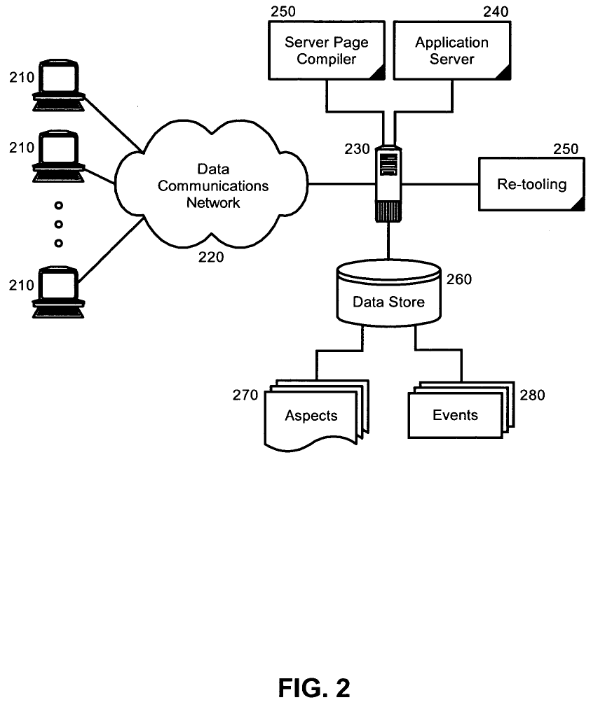

In more specific illustration, FIG. 2 is a schematic illustration of an application server configured for use with the re-tooling system, method and apparatus of FIG. 1. The system can include one or more server computing devices 230 (only one server computing device 230 shown for the purpose of simplicity) configured for coupling to one or more client computing devices 210 over a data communications network 220. The server computing device 230 can host an application server 240 configured for use with a server page compiler 250. The combination of the application server 240 and the server page compiler 250 can operate to compile and render server pages for use by one or more users through the client computing devices 210.

The server computing device 230 also can be coupled to one or more data stores 260 (only one data store shown for the purpose of illustrative simplicity) which can store a set of events 280, and a set of aspects 270. Notably, individual ones of the aspects 270 can be associated with individual ones of the events 280. Finally, the server computing device 230 can host a re-tooling process 250. The re-tooling process 250 can be programmed to detect conditions in the server computing device 230 which can be mapped to individual ones of the events 280. Based upon a mapping of an event 280 to a condition, one or more aspects 270 can be selected by the re-tooling process 250 for weaving into server page code hosted through the application server 240.

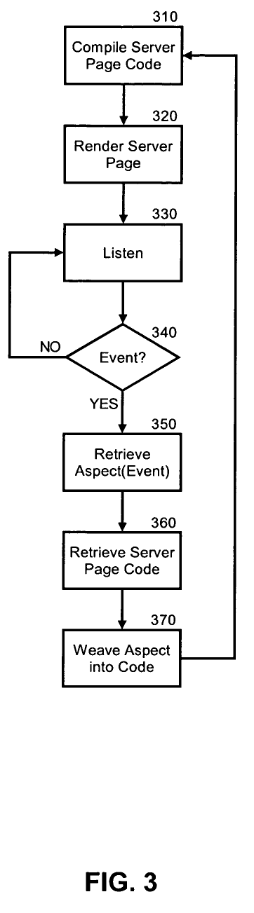

As an example, FIG. 3 is a flow chart illustrating a process for re-tooling a server page in the system of FIG. 2. The process can begin in block 310 in which server page code can be compiled into a server page suitable rendering and distribution to communicatively coupled client browsers. In block 320, the server page can be processed and rendered for distribution to coupled client browsers. Subsequently, in block 330, the application server or an associated listening process can monitor the operation of the application server for conditions which map to events. If in decision block 340 an event is detected, in block 350 a corresponding aspect can be retrieved. The server page code currently operating through the application similarly can be retrieved in block 360 and in block 370 the aspect can be weaved into the server page code.

Once the aspect has been weaved into the server page code in block 370, the process can return to block 310 in which the now modified server page code is recompiled and processed normally through a rendering of the recompiled server page in the application server. As a result of the foregoing process, an aspect appropriate for the detected event can be weaved into the server page code only when required and without burdening the logic of the server page with equivalent non-aspect code.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A server page re-tooling method comprising the steps of:
detecting a condition related to a compiled form of server page code;
mapping said detected condition to aspect code; and,
weaving said mapped aspect code with said server page code to produce re-tooled server page code

2. The method of claim 1, further comprising the step of providing said re-tooled server page code to a server page compiler.

3. The method of claim 1, further comprising the step of compiling and executing said re-tooled server page code.

4. The method of claim 1, wherein said detecting step comprises the step of detecting one of an operational and an environmental condition.

5. The method of claim 1, further comprising the steps of:
further detecting a different condition related to a compiled form of said re-tooled server page code;
further mapping said further detected condition to other aspect code;
discarding re-tooled server page code; and,
further weaving said further mapped aspect code with said server page code to product additional re-tooled server page code

6. The method of claim 5, further comprising the step of compiling and executing said re-tooled server page code.

7. A system for programmatically re-tooling a server page comprising:
a server page compiler; and,
a re-tooling process communicatively linked to said server page compiler and programmed to re-tool server page code with aspects selected based upon detected conditions.

8. The system of claim 7, further comprising a data store of aspects mapped to detectable conditions, said data store having a communicative coupling to said re-tooling processes.

9. The system of claim 7, further comprising an application server configured for operation with said server page compiler.

10. The system of claim 7, further comprising an aspect pre-compiler configured for use by said re-tooling process to produce server page code able to be compiled by said server page compiler.

11. A machine readable storage having stored thereon a computer program for server page re-tooling, the computer program comprising a routine set of instructions which when executed by a machine cause the machine to perform the steps of:
detecting a condition related to a compiled form of server page code;
mapping said detected condition to aspect code; and,
weaving said mapped aspect code with said server page code to produce re-tooled server page code

12. The machine readable storage of claim 11, further comprising further instructions for causing the machine to perform the step of providing said re-tooled server page code to a server page compiler.

13. The machine readable storage of claim 11, further comprising further instructions for causing the machine to perform the step of compiling and executing said re-tooled server page code.

14. The machine readable storage of claim 11, wherein said detecting step comprises the step of detecting one of an operational and an environmental condition.

15. The machine readable storage of claim 11, further comprising further instructions for causing the machine to perform the steps of:
further detecting a different condition related to a compiled form of said re-tooled server page code;
further mapping said further detected condition to other aspect code;
discarding re-tooled server page code; and,
further weaving said further mapped aspect code with said server page code to product additional re-tooled server page code

16. The machine readable storage of claim 15, further comprising further instructions for causing the machine to perform the step of compiling and executing said re-tooled server page code.
